(19) United States
(12) Patent Application Publication
(10) Pub. No.: US 2022/0113160 A1
(43) Pub. Date: Apr. 14, 2022

(54) NON-TRANSITORY COMPUTER READABLE STORAGE MEDIUM STORING ROAD ESTIMATION PROGRAM, ROAD ESTIMATION METHOD, AND ROAD ESTIMATION APPARATUS

(71) Applicant: KAWASAKI JUKOGYO KABUSHIKI KAISHA, Kobe-shi (JP)

(72) Inventor: Hisato TOKUNAGA, Kobe-shi (JP)

(73) Assignee: KAWASAKI JUKOGYO KABUSHIKI KAISHA

(21) Appl. No.: 17/490,490

(22) Filed: Sep. 30, 2021

(30) Foreign Application Priority Data
Oct. 12, 2020 (JP) 2020-171774

(51) Int. Cl. G01C 21/00; G06N 20/00

(52) U.S. Cl. CPC G01C 21/3815; G06N 20/00; G01C 21/3848

(57) ABSTRACT

There are provided a non-transitory computer readable storage medium, a road estimation method, and a road estimation apparatus. The storage medium stores a program causing a computer to execute a road estimation process, the road estimation process including: receiving, as an input step, positioning data obtained by a plurality of runs of at least one movable body; generating, as a running lines generation step, a plurality of running lines respectively indicating running routes of the plurality of runs, on the basis of the positioning data; and generating, as a road determination step, a representative line from among a set of the plurality of running lines on the basis of passage frequencies of the plurality of running lines, to determine the generated representative line as a road line.

### CROSS-REFERENCE TO RELATED APPLICATIONS

This application is based on and claims priority under 35 USC 119 from Japanese Patent Application No. 2020-171774 filed on Oct. 12, 2020, the contents of which are incorporated herein by reference.

### TECHNICAL FIELD

The present disclosure relates to a non-transitory computer readable storage medium storing a road estimation program, a road estimation method, and a road estimation apparatus.

### BACKGROUND ART

Map information generation systems have been proposed that generate information of a new road that does not exist in map information based on plural pieces of positioning data (refer to JP5029009B2, for example). JP5029009B2 discloses a system that generates new road information by classifying plural running loci spaced from each other by distances within a prescribed distance out of plural running loci obtained from satellite positioning data into a same group, of and determining a center line of the running loci belonging to the same group as a representative line.

However, when grouping is made on the basis of separation distances between running loci, running loci of different roads may be determined erroneously as the same road depending on the degree of proximity of different roads and the degree of variation of errors of satellite positioning data. For example, when a new road includes an intersection as in the case of a crossroads or Y-shaped roads, since the adjacent roads are close to each other around the intersection, a place without a road may be regarded as a new road if middle points between running loci are determined to be representative points.

### SUMMARY OF INVENTION

The present disclosure relates to a non-transitory computer readable storage medium storing program, a method and an apparatus for a road estimation which can improve accuracy in estimating a road from positioning data.

According to an aspect of the present disclosure, a non-transitory computer readable storage medium stores a program causing a computer to execute a road estimation process. The road estimation process includes: receiving, as an input step, positioning data obtained by a plurality of runs of at least one movable body; generating, as a running lines generation step, a plurality of running lines respectively indicating running routes of the plurality of runs, on the basis of the positioning data; and generating, as a road determination step, a representative line from among a set of the plurality of running lines on the basis of passage frequencies of the plurality of running lines, to determine the generated representative line as a road line.

According to another aspect of the present disclosure, a road estimation method includes: acquiring, as a positioning data acquisition step, a plurality of positioning data indicating a set of passage coordinates for each of runs; generating, as a running lines generation step, a coordinate information for each of running routes to be a plurality of running lines on the basis of the plurality of positioning data; extracting, as a candidate extraction step, a plurality of running lines included in a target coordinate area to be determined as a set of road coordinates from among the plurality of running lines obtained by the running lines generation step; generating, a superimposition information generation step, a superimposition information in which the plurality of running lines extracted by the candidate extraction step are superimposed in the target coordinate area, to set a frequency value for each of coordinates within the target coordinate area in the superimposition information in accordance with passage frequencies of the plurality of running lines; and generating, as a road determination step, one representative line within the target coordinate area on the basis of the frequency value for each of the coordinates in the superimposition information, to determine the generated representative line as a road line.

The non-transitory computer readable storage medium that stores the road estimation program may be incorporated in or attached externally to a computer (e.g., portable information terminal, personal computer, or server). The storage medium may be, for example, a hard disk drive, a flash memory, a ROM, a RAM, or an optical disc. The road determination program may be run by a computer to which the storage medium is connected directly or a computer that is connected to the storage medium via a network (e.g., Internet).

According to another aspect of the present disclosure, a road estimation apparatus includes a processor configured to read out a program to execute: receiving, as an input unit, positioning data obtained by a plurality of runs of at least one movable body; generating, as a running lines generation unit, a plurality of running lines respectively indicating running routes of the plurality of runs, on the basis of the positioning data; and generating, as a road determination unit, a representative line from among a set of the plurality of running lines on the basis of passage frequencies of the plurality of respective running lines, to determine the generated representative line as a road line.

In each of the above aspects of the present disclosure, a representative line is generated as a road line on the basis of passage frequencies (i.e., the degree of superimposition) of running lines generated from positioning data. Accordingly, since a representative line is generated by taking passage frequencies of plural runs into consideration, it becomes less likely to erroneously determine running loci on different roads such as a crossroads or Y-shaped roads, as the same road. Therefore, the road estimation accuracy can thus be improved.

Accordingly, the present disclosure makes it possible to improve the accuracy in estimating a road from positioning data.

### BRIEF DESCRIPTION OF DRAWINGS

FIG. 1 is a schematic diagram of a road estimation system according to an embodiment;

FIG. 2 is a block diagram of the road estimation system shown in FIG. 1;

FIG. 3 shows a format of a signal that is transmitted from a transmitter of each vehicle-side device to a server;

FIG. 4 is a flowchart of a road estimation process that is executed by the server;

FIG. 5 is a conceptual diagram of a learning model to be used by a road determination unit of the server;

FIG. 6A shows a line image including plural running lines;

FIG. 6B shows a representative line (road line) generated from the line image shown in FIG. 6A;

FIG. 7A shows a line image including plural running lines of a crossroads;

FIG. 7B shows a line image including plural running lines of Y-shaped roads;

FIG. 8 is a diagram showing a search region to be used for determining discrete representative points from the representative line shown in FIG. 6B; and

FIG. 9 is a diagram illustrating another method for generating a representative line from the line image shown in FIG. 6A.

### DETAILED DESCRIPTION OF EMBODIMENTS

An embodiment will be hereinafter described with reference to the drawings.

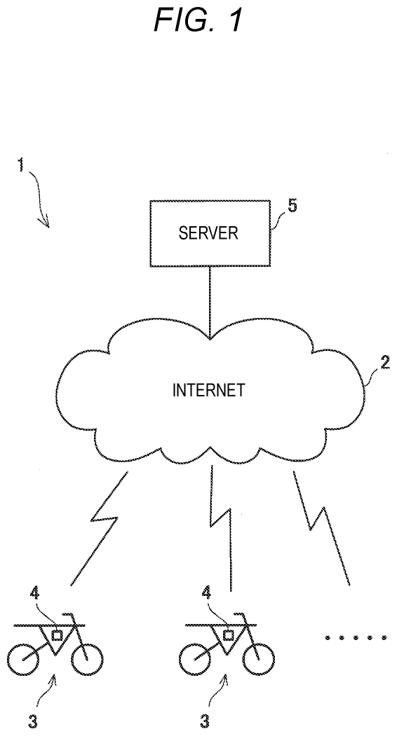

FIG. 1 is a schematic diagram of a road estimation system 1 according to the embodiment. As shown in FIG. 1, the road estimation system 1 includes plural vehicles 3, each of which is equipped with a vehicle-side device 4 capable of connecting to a network 2 (e.g., Internet), and a server 5 (road estimation apparatus) capable of connecting to the network 2. Each of the vehicle-side devices 4 and the server 5 is a computer that includes a processor, a memory, a communication interface, etc.

A type of the vehicle 3 in the embodiment is not particularly limited. It may be preferable that the vehicles 3 are saddle-type vehicles (e.g., motorcycles) whose width is relatively short as compared with road widths. A single vehicle 3 may be employed rather than plural vehicles 3. The vehicle-side device 4 may be either an information processing device that is built in or separately attached to each vehicle 3 or a portable information terminal held by a user riding on or driving the vehicle 3. Alternatively, users each carrying a device 4 may move by bicycle or walk without using any vehicle 3. That is, the movable body that is accompanied by a device 4 is not limited to a vehicle 3 having a drive power source and may be a bicycle or a user (i.e., human).

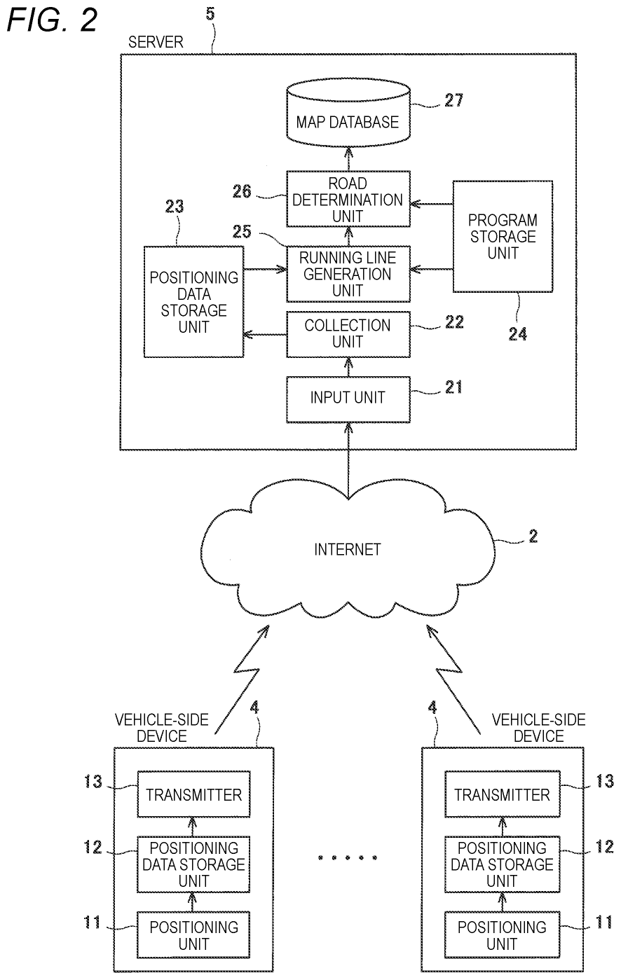

FIG. 2 is a block diagram of the road estimation system 1 shown in FIG. 1. As shown in FIG. 2, each vehicle-side device 4 includes a positioning unit 11, a positioning data storage unit 12, a transmitter 13, etc. The positioning unit 11 moves together with the vehicle 3, and receives, every prescribed time, as positioning data, position coordinates of the vehicle 3 on the earth using a satellite positioning system (e.g., GPS or quasi-zenith satellite system). Since positioning data obtained by using satellites has relatively large errors, running loci may be different from each other even when they are obtained by vehicles 3 that have run on the same road plural times.

Positioning data, which is plural sets of position coordinates, is not limited to data obtained by a satellite positioning system. For example, the positioning unit 11 may acquire a running direction from an acceleration direction detected by an acceleration sensor installed in the vehicle 3 and acquire a running displacement from a wheel rotation speed detected by a wheel rotation speed sensor installed in the vehicle 3 and generate positioning data on the basis of the acquired running direction and running displacement. As a further alternative, the positioning unit 11 may use both of satellite positioning and onboard sensors so as to generate positioning data by the satellite positioning when the satellite positioning is possible so and generate positioning data using the onboard sensors (e.g., acceleration sensor and speed sensor) without using the satellite positioning when the satellite positioning is impossible (e.g., in a case that the satellite positioning is obstructed by buildings or a tunnel).

The positioning data storage unit 12 sequentially stores positioning data received by the positioning unit 11 together with reception times. The transmitter 13 is configured to be communicatable with the server 5 to be hereinafter described. In the embodiment, the transmitter 13 is configured to be communicatable with the server 5 over the network 2 (e.g., public data network or wireless LAN). Information transmitted from the transmitter 13 to the server 5 may include type information indicating a movable body type (e.g., automobile, motorcycle, bicycle, or user) in addition to positioning data (i.e., sets of coordinates), positioning data reception times, and movable body identification information.

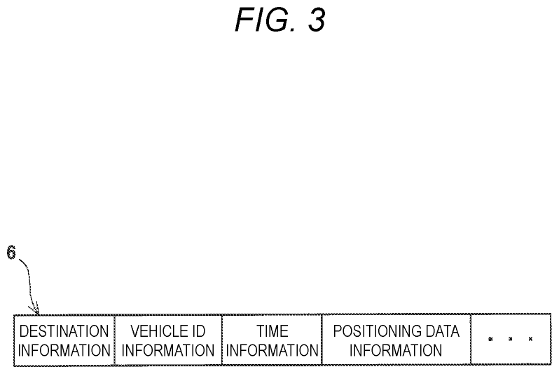

The server 5 includes an input unit 21, a collection unit 22, a positioning data storage unit 23, a program storage unit 24, a running line generation unit 25, a road determination unit 26, and a map database 27. The input unit 21 receives a signal 6 (see FIG. 3) that is transmitted from the transmitter 13 of the vehicle-side device 4 of each vehicle 3 over the network 2. That is, the signals 6 containing positioning data of plural runs detected by the positioning units 11 of the vehicle-side devices 4 are input to the input unit 21, respectively. The collection unit 22 collects positioning data from the signals 6 that have been input to the input unit 21. The positioning data storage unit 23 accumulates and stores the positioning data collected by the collection unit 22. That is, the positioning data storage unit 23 stores positioning data that are sent from each vehicle-side device 4 sequentially.

The program storage unit 24 stores therein road estimation programs that are installed in the server 5. The running line generation unit 25 and the road determination unit 26 are realized by the processor's reading-out the road estimation programs into a main memory and executing them. The running line generation unit 25 generates plural running lines indicating running routes of plural runs on the basis of the positioning data stored in the positioning data storage unit 23. Each running line is line information of each run obtained by connecting plural sets of position coordinates.

In other words, each running line is a line that connects positioning data (i.e., sets of vehicle position coordinates) that are detected in order at every prescribed time. For example, each running line may be either a line representing a collection of sets of coordinates or a function involving coordinate parameters and indicating a line. For example, each running line may be information obtained by connecting adjacent pieces of positioning data by a straight line. Running lines may be either lines indicating running routes of plural respective vehicles 3 or lines indicating routes taken by plural runs of a single vehicle 3 on the same road.

The road determination unit 26 determines a representative line as a road line from plural running lines generated by the running line generation unit 25. The map database 27 is stored with map information. The map information stored in the map database 27 is updated by addition, to the current map information, of information of a road newly determined by the road determination unit 26.

FIG. 3 shows a format of a signal 6 that is sent from the transmitter 13 of each vehicle-side device 4 to the server 5. As shown in FIG. 3, a signal 6 transmitted from each vehicle-side device 4 includes destination information, vehicle ID information, time information, positioning data information, etc. The destination information is identification information of the server 5 indicating that the transmission destination is the server 5. The vehicle ID information is identification information of the vehicle-side device 4. The time information is information indicating a time of measurement of positioning data included in the signal 6 (i.e., a time of acquisition of the positioning data by the positioning unit 11). The positioning data information is information of positioning data acquired by the positioning unit 11.

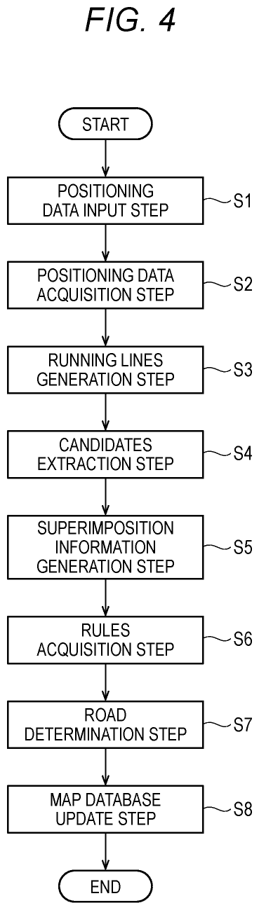

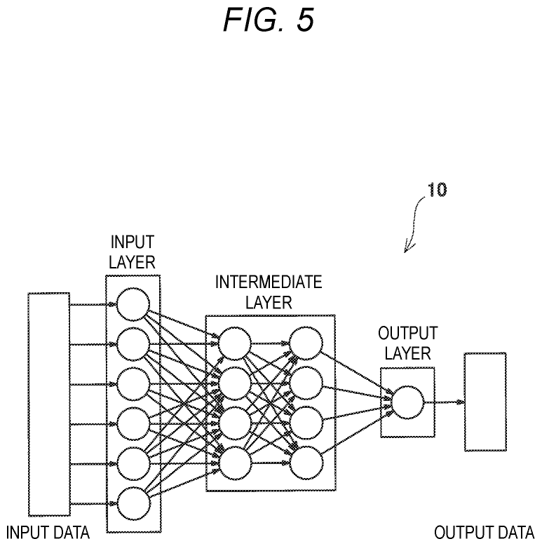

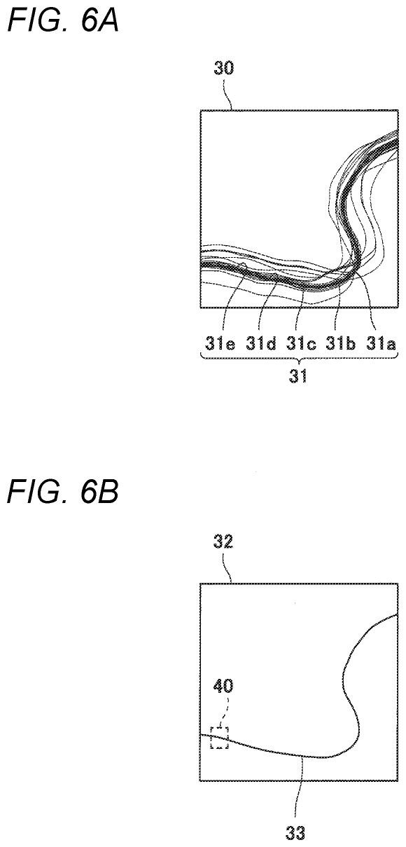

FIG. 4 is a flowchart of a road estimation process that is executed by the server 5 shown in FIG. 2. FIG. 5 is a conceptual diagram of a learning model 10 to be used by the road determination unit 26 of the server 5 shown in FIG. 2. FIG. 6A shows a line image 30 including plural running lines 31a, 31b, 31c, 31d, 31e, . . . and FIG. 6B shows a representative line 33 (road line) generated from the line image 30 shown in FIG. 6A. The road estimation process will be described below according to the flowchart of FIG. 4 by referring to FIGS. 2, 4, 5, 6A and 6B.

First, at step S1 (positioning data input step), time-series positioning data detected by the positioning units 11 of the vehicle-side devices 4 at a time when the plural vehicles 3 are running are transmitted from the transmitters 13 to the server 5. The positioning data that have been input to the input unit 21 of the server 5 are stored in the positioning data storage unit 23. The transmitter 13 may either transmit positioning data in real time during running of the vehicle 3 or transmit positioning data stored in the positioning data storage unit 12 together after completion of a run of the vehicle 3.

At step S2 (positioning data acquisition step), the running line generation unit 25 acquires the positioning data (i.e., plural sets of position coordinates) stored in the positioning data storage unit 23. The positioning data is, in other words, plural pieces of positioning data indicating sets of coordinates passed of each run.

At step S3 (running lines generation step), the running line generation unit 25 generates plural running lines 31a, 31b, 31c, 31d, 31e, . . . indicating running routes of plural runs on the basis of the acquired plural pieces of positioning data. Each running line includes pieces of two-dimensional coordinate information of a running route.

At step S4 (candidate extraction step), the road determination unit 26 extracts plural running lines included in a target coordinate area where to determine sets of road coordinates (i.e., latitudes and longitudes) from the running lines 31a, 31b, 31c, 31d, 31e, . . . The road determination unit 26 sets, as a line image 30, an image area that is a collection of plural pixels each of which is a region defined by a prescribed latitude range and a prescribed longitude range. The target coordinate area is the area of the line image 30 shown in FIG. 6A, and the size of the area of the line image 30 is determined in a desired manner according to a computation ability etc. of the server 5.

At step S5 (superimposition information generation step), the road determination unit 26 generates a running line set 31 (i.e., superimposition information) in which the plural running lines 31a, 31b, 31c, 31d, 31e, . . . extracted in the target coordinate area are superimposed on each other. For example, the road determination unit 26 generates a line image 30 in which images including the plural respective running lines 31a, 31b, 31c, 31d, 31e, . . . are superimposed on each other to form a layer of a running line set 31. In the running line set 31, frequency values corresponding to passage frequencies of the plural running lines 31a, 31b, 31c, 31d, 31e, . . . are set on a pixel-by-pixel basis.

For example, a line image 30 is generated through conversion into a grayscale image (e.g., 256 gradation levels) in which the lightness of each pixel decreases as its frequency value increases. That is, a line image 30 is generated as a grayscale multigradation image including the plural running lines 31a, 31b, 31c, 31d, 31e, . . . in which the darkness of a pixel representing points of running lines increases (i.e., the lightness decreases) as the degree of superimposition of the running lines increases there. The line image 30 is a rectangular image including the plural running lines 31a, 31b, 31c, 31d, 31e, . . . In this manner, three-dimensional information in which in addition to sets of two-dimensional coordinates gradation values are set for the respective sets of coordinates is generated in the line image 30.

The area of the line image 30 corresponds to the target coordinate area, the position of each pixel of the line image 30 means coordinates (i.e., latitude and longitude), and the darkness of each pixel of the line image 30 means a frequency value at each set of coordinates (in other words, at each pixel). Alternatively, the line image 30 may be such that the darkness of a pixel representing points of running lines decreases (the lightness increases) as the degree of superimposition of the running lines 31a, 31b, 31c, 31d, 31e, . . . increases there.

At step S6 (rules acquisition step), the road determination unit 26 acquires road determination rules. More specifically, as shown in FIG. 5, a learning model 10 learnt by machine learning is used as road determination rules. For example, the learning model 10 is a CNN (convolutional neural network) model. In the learning model 10 employed in the embodiment, in first to sixth layers, a ReLU is employed as an activation function and a bias thereof is set equal to 0. In third and fourth layers, a dropout is provided and a value p is set equal to 0.5. In a seventh layer, a sigmoid is employed as the activation function and a bias thereof is set equal to 1.

Training data are prepared in advance in which input data are a line image including plural running line data with large coordinate variations and resulting output data is a representative line image 32 including true road coordinate data (i.e., road line data) of actual passage of the input running lines, and are used for machine learning of the learning model 10 in advance. The training data may be such that plural pieces of running line data as input data vary according to two-dimensional normal distributions and true road coordinate data as output data have sets of coordinates correspond to peaks of the two-dimensional normal distributions. That is, true road coordinate data may be defined as coordinates that a frequency of occurrence (i.e., degree of superimposition) of running lines is the highest in a set of plural running line data.

At step S7 (road determination step), the road determination unit 26 inputs the line image 30 to the above learning model 10 as input data and acquires a representative line image 32 that is output from the learning model 10. That is, the road determination unit 26 generates one representative line 33 from the running line set 31 on the basis of the darkness value of the respective pixels in the line image 30 and determines to employ the generated representative line 33 as a road line. As a result, one representative line 33 is generated on the basis of sets of coordinates where the frequency of occurrence of the running lines 31a, 31b, 31c, 31d, 31e, . . . (their passage frequency) is high among the coordinates configured from a low frequency of occurrence and a high frequency of occurrence.

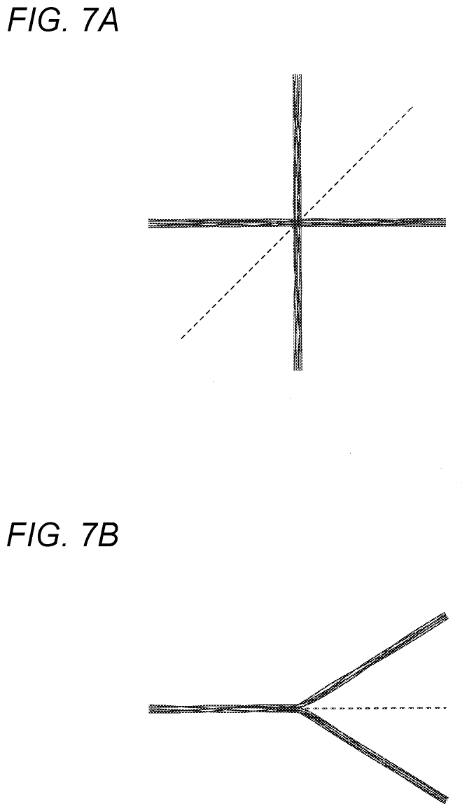

By following the above process, even in a case of a crossroads where a running line set assumes approximately a cross shape (see FIG. 7A), a case of Y-shaped roads where a running line set assumes approximately a Y shape (see FIG. 7B), or a like case, it becomes possible to prevent a line indicated by a broken line in each of FIGS. 7A and 7B from being employed erroneously as a representative line.

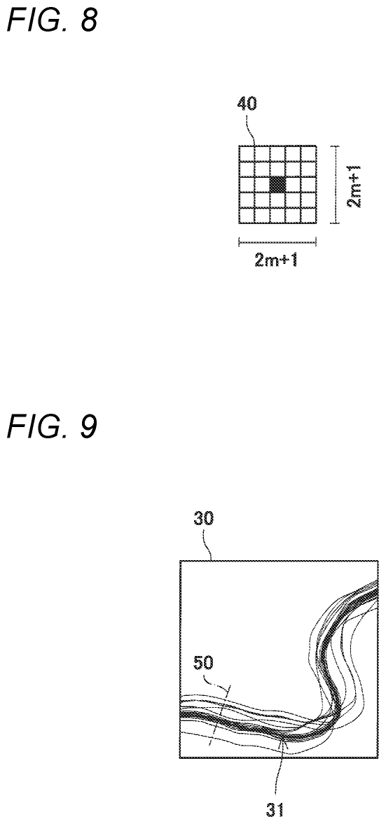

At step S7 (road determination step), the road determination unit 26 sets search regions 40 sequentially which are partial regions of the representative line image 32 including the generated representative line 33 such that the search region 40 is moved in the representative line image 32 step by step (search region setting step). As shown in FIG. 8, the search region 40 consists of (2m+1) pixels that are arranged in each of the vertical and horizontal directions (where m is a natural number). If the center pixel of the search region 40 has the greatest darkness value (i.e., lowest lightness) in the search region 40, the road determination unit 26 employs the coordinates of the center of the search region 40 as the coordinates of a representative point to constitute the representative line 33 (representative points determination step). In the above-described manner, the road determination unit 26 acquires plural representative points as a discrete version of the representative line 33. That is, the discrete representative points constitute a part of the representative line 33 and have sets of coordinate information of respective points. The representative line 33 can be obtained by backward calculation by connecting the representative points smoothly (i.e., by performing interpolation between the representative points). The step of determining representative points may be omitted.

At step S8 (map database update step), the road determination unit 26 updates the map information in the map database 27 using the thus-determined representative points. That is, the road determination unit 26 adds the representative line 33 estimated at step S7 or an arrangement of its representative points as a new road in an area having no road information in the map information of the map database 27.

FIG. 9 is a diagram illustrating another method for generating a representative line from the line image 30 shown in FIG. 6A. The road determination unit 26 may employ the following technique instead of using the learning model 10 as road determination rules. As shown in FIG. 9, a cross line 50 perpendicular to one running line 31a included in the running line set 31 is set in the line image 30, and is moved sequentially along the running line 31a.

Then a pixel having the greatest darkness value (i.e., minimum lightness) among the pixels located on the cross line 50 is determined, and a set of pixels each determined as having the greatest darkness value in each of cross lines that are set sequentially are employed as a representative line 33 (see FIG. 6B). In this manner, a representative line 33 can also be determined as a road line from the line image 30.

Another, existing image processing method may be employed as a method for extracting a representative line from a grayscale multigradation image in which overlap portions of plural running lines are darker. As for the priority to be selected as pixels that configure a representative line, the priority of high-frequency (i.e., high-darkness value) pixels may be given higher priority than low-frequency (i.e., low-darkness value) pixels. That is, a pixel having a higher frequency may be given a larger weight for selected as a representative pixel. For example, road determination rules may include a rule that the minimum radius of curvature of a road line should be larger than a prescribed value or a rule that adjacent running lines are not employed as candidates for a single road line if their separation distance is longer than a prescribed value.

In the above-described configuration, a representative line 33 is generated as a road line on the basis of passage frequencies (i.e., the degree of superimposition) of running lines 31a, 31b, 31c, 31d, 31e, . . . generated from positioning data. Accordingly, since a representative line 33 is generated by taking passage frequencies of plural runs into consideration, it becomes less likely to erroneously determine running loci on different roads such as a crossroads or Y-shaped roads, as the same road. The road estimation accuracy can thus be improved.

Positions of a road can be estimated with high accuracy by running on the road repeatedly, which makes it unnecessary to perform a road surface measurement. For example, position information of a road that is not found in the map information of the map database 27 (e.g., a new road or a road on which four-wheel vehicles cannot run) can be acquired by estimation that is performed on the basis of positioning data obtained by repeated runs. Furthermore, a road can be estimated with higher accuracy by performing road estimation for each kind of movable body (e.g., two-wheel vehicle or four-wheel vehicle).

Since a representative line 33 is determined on the basis of darkness value of pixels in a line image 30, the probability of occurrence of an erroneous road judgment can be lowered by simple processing. Since a representative line 33 is determined from a line image 30 using the learning model 10, a road can be estimated with high accuracy by machine learning. Even without using machine learning, a road can be estimated with high accuracy by generating a representative line 31 of a running line set 31 on the basis of passage frequencies of running lines as shown in FIG. 9.

Since discrete representative points constituting a representative line 33 are determined, not only can a representative line be determined in a simple manner by employing, as representative points, positions where the degree of superimposition of running lines in a line image 30 is high but also the data amount can be prevented from becoming enormous. Furthermore, even if positions where positioning data occur vary in the road extension direction from one vehicle to another in a case that state values of respective vehicles running on an estimated road are evaluated relative to each other, the evaluation can be performed easily by setting discrete representative points as road information.

That is, positioning data existing in a blank region between representative points in the direction along a road line may be regarded as existing at a closest representative point, which makes it possible to compare sets of states (e.g., bank angle, vehicle speed, acceleration, tire force, brake pressure, throttle position, and steering angle) of running vehicles at the same running position. Evaluation target vehicle state values can be compared with comparison state values (e.g., average values, or state values of a particular vehicle) easily.

By correlating vehicle ID information (i.e., identification information) with positioning data and reception times, even if plural pieces of positioning data are stored in the server 5 at the same time point, running lines corresponding to respective pieces of vehicle ID information can be generated and hence generation of an erroneous running line can be prevented.

The above-described road estimation may be performed for each kind of movable body (e.g., automobile, motorcycle, bicycle, or walking user). This makes it possible to suppress estimation errors in the case where different running positions are set on a road depending on kinds of movable bodies. Furthermore, a road may be estimated by correcting estimation coordinates for each kind of movable body. This makes it possible to suppress estimation errors in the case where different running positions are set on a road depending on kinds of movable bodies.

A signal 4 may include discrimination information indicating whether positioning data information have been generated by satellite positioning or by a vehicular onboard sensor. For example, in road estimation performed on the basis of positioning data generated by a vehicular onboard sensor, the number of positioning data necessary for road determination may be set larger than in the case of satellite positioning. This makes it possible to prevent reduction of the accuracy of road estimation even in the case where errors of positioning data generated by a vehicular onboard sensor tend to be large.

Conditions (e.g., turn radii and/or a road width) that should be satisfied by a road may be set in advance as road determination rules other than those obtained by machine learning and a representative line that satisfies those conditions may be determined as a road line. For example, where road determination rules that vary depending on additional vehicular information such as a running speed and blinker operation information, discrimination between road types (e.g., an expressway and a city road) can be made depending on a vehicle state, whereby the road estimation accuracy can be improved. For example, road determination rules for expressways may be used when a vehicle is in a situation of high-speed running. In the case of a vehicle situation that the vehicle is started and stopped repeatedly, road determination rules for city roads may be used. In the case of a vehicle situation that the bank angle variation of a lean vehicle (e.g., motorcycle) is large and is repeated, road determination rules for winding roads may be used.

Not only the server 5 but also a portable terminal or a processing device installed in a vehicle body may serve as the road estimation apparatus or device. The road estimation accuracy may be improved by increasing the number of stored positioning data by, for example, causing processing devices of respective vehicles to exchange positioning data when they pass each other during running.

Road estimation may be performed by referring to information relating to running directions. For example, the accuracy can be improved by eliminating positioning data of vehicles that run on an opposite lane by performing road estimation such that positioning data of vehicles running in the opposite direction are eliminated.

What is claimed is:

1. A non-transitory computer readable storage medium storing a program causing a computer to execute a road estimation process, the road estimation process comprising:
receiving, as an input step, positioning data obtained by a plurality of runs of at least one movable body;
generating, as a running lines generation step, a plurality of running lines respectively indicating running routes of the plurality of runs, on the basis of the positioning data; and
generating, as a road determination step, a representative line from among a set of the plurality of running lines on the basis of passage frequencies of the plurality of running lines, to determine the generated representative line as a road line.

2. The non-transitory computer readable storage medium according to claim 1, wherein:
the running lines generation step includes generating a line image that is a multigradation line image including the plurality of running lines and in which a darkness value for each of pixels of the running lines varies as a degree superimposed between the running lines increases; and
the road determination step includes generating the representative line of the plurality of running lines on the basis of the darkness value for each of the pixels in the line image.

3. The non-transitory computer readable storage medium according to claim 2, wherein the road determination step includes determining the representative line on the basis of the line image generated by the running lines generation step, using a learning model that has completed a machine learning with a training data having the multigradation line image including a plurality of running lines prepared in advance and a road line prepared in advance.

4. The non-transitory computer readable storage medium according to claim 1, wherein the road determination step includes:
setting a search region by sequentially moving the search region within the representative line image including the generated representative line, the search region being a partial region of the representative line image; and
determining coordinates of a center of the search region as coordinates of a representative point forming the representative line, in a case where a center pixel of the search region has the greatest darkness value in the search region.

5. A road estimation method comprising:
acquiring, as a positioning data acquisition step, a plurality of positioning data indicating a set of passage coordinates for each of runs;
generating, as a running lines generation step, a coordinate information for each of running routes to be a plurality of running lines on the basis of the plurality of positioning data;
extracting, as a candidate extraction step, a plurality of running lines included in a target coordinate area to be determined as a set of road coordinates from among the plurality of running lines obtained by the running lines generation step;
generating, a superimposition information generation step, a superimposition information in which the plurality of running lines extracted by the candidate extraction step are superimposed in the target coordinate area, to set a frequency value for each of coordinates within the target coordinate area in the superimposition information in accordance with passage frequencies of the plurality of running lines; and
generating, as a road determination step, one representative line within the target coordinate area on the basis of the frequency value for each of the coordinates in the superimposition information, to determine the generated representative line as a road line.

6. The road estimation method according to claim 5, wherein the road determination step includes generating the one representative line on the basis of a group of coordinates in which the frequency value is high among the coordinates configured from a low frequency value and a high frequency value.

7. The road estimation method according to claim 5, further comprising acquiring, as a rules acquisition step, a road determination rule, wherein the road determination step includes determining the road line on the basis of the frequency value for each of the coordinates in the superimposition information and the road determination rule.

8. A road estimation apparatus comprising:
a processor configured to read out a program to execute:
receiving, as an input unit, positioning data obtained by a plurality of runs of at least one movable body;
generating, as a running lines generation unit, a plurality of running lines respectively indicating running routes of the plurality of runs, on the basis of the positioning data; and
generating, as a road determination unit, a representative line from among a set of the plurality of running lines on the basis of passage frequencies of the plurality of respective running lines, to determine the generated representative line as a road line.

9. The road estimation apparatus according to claim 8, wherein the processor executes:
in the running lines generation unit, generating a line image that is a multigradation line image including the plurality of running lines and in which a darkness value for each of pixels of the running lines varies as a degree superimposed between the running lines increases; and
in the road determination unit, generating the representative line of the plurality of running lines on the basis of the darkness value for each of the pixels in the line image.

10. The road estimation apparatus according to claim 9, wherein the processor executes, in the road determination unit, determining the representative line on the basis of the line image generated by the running lines generation step, using a learning model that has completed a machine learning with a training data having the multigradation line image including the plurality of running lines prepared in advance and the road line prepared in advance.

11. The road estimation apparatus according to claim 8, wherein the processor executes, in the road determination unit:
setting a search region by sequentially moving the search region within the representative line image including the generated representative line, the search region being a partial region of the representative line image; and
determining coordinates of a center of the search region as coordinates of a representative point forming the representative line, in a case where a center pixel of the search region has the greatest darkness value in the search region.

12. The road estimation apparatus according to claim 8, wherein the processor is provided in at least one of a server, a portable terminal, and a processing device installed in the at least one movable body.
